(19) United States
(12) Patent Application Publication
(10) Pub. No.: US 2009/0231318 A1
(43) Pub. Date: Sep. 17, 2009

(54) COLUMN SELECT SIGNAL ADJUSTING CIRCUIT CAPABLE OF REDUCING INTERFERENCE BETWEEN BIT LINES AND DATA LINES AND SEMICONDUCTOR MEMORY DEVICE HAVING THE SAME

(75) Inventor: Sang Ho Lee, Ichon (KR)

Correspondence Address: BAKER & MCKENZIE LLP;PATENT DEPARTMENT, 2001 ROSS AVENUE, SUITE 2300, DALLAS, TX, 75201, US

(73) Assignee: HYNIX SEMICONDUCTOR INC., Ichon (KR)

(21) Appl. No.: 12/337,509

(22) Filed: Dec. 17, 2008

(30) Foreign Application Priority Data
Mar. 12, 2008 (KR) 10-2008-0023029

(51) Int. Cl. G09G 5/00

(52) U.S. Cl. 345/211

(57) ABSTRACT

Disclosed is a column select signal adjusting circuit capable of reducing interference between bit lines and data lines and a semiconductor memory device having the same. The column select signal voltage adjusting circuit includes a driving voltage generating unit for producing a driving voltage when the write signal is activated, wherein a voltage level of the driving voltage produced when the write signal is activated is higher than a voltage level of the driving voltage produced when the write signal is inactivated, and a column select signal driving unit for outputting a column select signal by driving a decoding signal to the voltage level of the driving voltage.

### CROSS-REFERENCES TO RELATED APPLICATION

The present application claims priority under 35 U.S.C. § 119(a) to Korean application number 10-2008-0023029, filed on Mar. 12, 2008, in the Korean Intellectual Property Office, which is incorporated by reference in its entirety as set forth in full.

### BACKGROUND

The embodiments described here relate to a semiconductor integrated circuit and, more particularly, to a column select signal adjusting circuit and a semiconductor memory apparatus having the same.

Generally, a semiconductor memory apparatus includes a plurality of memory cells so that data write and read operations are carried out in the memory cells of the semiconductor memory apparatus.

Bit lines and bit bar lines are used to store and read out the data in and from the semiconductor memory apparatus and hierarchical data lines are required to process a large amount of data in the semiconductor memory apparatus.

However, a conventional bit line and bit bar line is shorter than a data line and a data bar line which is disposed at a high rank. Accordingly, parasite capacitance of the bit line and the bit bar line is lower than that of the data line and the data bar line.

At this time, there is no problem when the data are transferred from the data line and the data bar line, which have a relative large amount of parasite capacitance, to the bit line and the bit bar line having the relative small amount of parasite capacitance.

However, in the case where the data are transferred from the bit line and the bit bar line, which have the relative small amount of parasite capacitance, to the data line and the data bar line which have the relative large amount of parasite capacitance, the voltage levels of the bit line and the bit bar line are varied due to the data line and the data bar line. This variation in the voltage levels of the bit line and the bit bar line can vary the data value stored in the memory cell.

### SUMMARY OF THE INVENTION

A column select signal adjusting circuit capable of reducing interference between bit lines and data lines and a semiconductor memory device having the same is described herein.

In one aspect, a column select signal voltage adjusting circuit of a semiconductor memory device include a driving voltage generating unit configured to receive a reference voltage and produce a driving voltage which has a voltage level corresponding to the reference voltage and configured to produce the driving voltage, which has a voltage level of an external voltage, in response to a write signal, a column select signal driving unit for outputting a column select signal by driving a decoding signal to the voltage level of the driving voltage.

In another aspect, a column select signal voltage adjusting circuit of a semiconductor memory device includes a driving voltage generating unit for producing a driving voltage when the write signal is activated, wherein a voltage level of the driving voltage produced when the write signal is activated is higher than a voltage level of the driving voltage produced when the write signal is inactivated, and a column select signal driving unit for outputting a column select signal by driving a decoding signal to the voltage level of the driving voltage.

In further another aspect, a semiconductor memory device includes a column select signal voltage adjusting circuit for producing a column select signal when the write signal is activated, wherein a voltage level of the column select signal produced when the write signal is activated is higher than a voltage level of the column select signal produced when the write signal is inactivated, and a data transfer switching unit for connecting a pair of bit lines to a pair of data lines in response to the column select signal.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a schematic block diagram illustrating a semiconductor memory device according to one embodiment;

FIG. 2 is a block diagram illustrating a column select signal voltage adjusting circuit of FIG. 1;

FIG. 3 is a circuit diagram illustrating a structure of an example of a driving voltage generating unit of FIG. 2;

FIG. 4 is a circuit diagram illustrating a structure of another example of a driving voltage generating unit of FIG. 2; and

FIG. 5 is a circuit diagram illustrating a structure of an example of a column select signal driving unit of FIG. 2.

### DETAILED DESCRIPTION

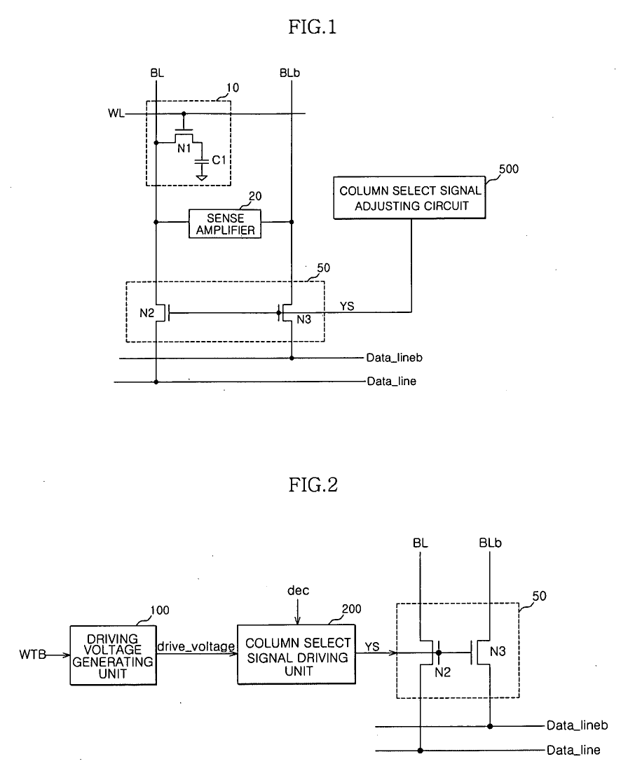

As shown in FIG. 1, a semiconductor memory apparatus according to one embodiment can include a pair of bit lines BL and BLB, a memory cell 10, a sense amplifier 20, a data transfer switching unit 50, a column select signal adjusting circuit 500, and a pair of data lines data_line and data_lineb.

The memory cell 10 can include a first transistor N1 coupled to a word line WL and the bit line BL and a capacitor C1 coupled to the first transistor N1. When the word line WL is activated, the capacitor C1 of the memory cell 10 stores data or the stored data are transferred to the bit line BL.

The sense amplifier 20 can amplify a voltage difference between the bit line BL and the bit bar line BLB. The voltage difference is generated when the data are transferred to the bit line BL.

The data transfer switching unit 50 can selectively transfer the voltage levels of the bit line BL and the bit bar line BLB, which is amplified by the sense amplifier 20, to the data line data_line and the data bar line data_lineb, respectively. The data transfer switching unit 50 can include two transistors N2 and N3 which couple the bit line BL and the bit bar line BLB to the data line data_line and the data bar line data_lineb, respectively. These two transistors N2 and N3 can be used as switches in response to a column select signal YS from the column select signal adjusting circuit 500.

Referring to FIG. 2, the column select signal adjusting circuit 500 can include a driving voltage generating unit 100 and a column select signal driving unit 200.

The driving voltage generating unit 100 can be configured to generate a driving voltage drive_voltage in response to a write signal WTB. For example, the driving voltage generating unit 100 can generate the driving voltage drive_voltage at a relative high voltage level when the write signal WTB is activated and can generate the driving voltage drive_voltage at a relative low voltage level when the write signal WTB is inactivated. The driving voltage generating unit 100 can output the driving voltage drive_voltage at a voltage level of an external voltage VDD when the write signal WTB is activated and can output the driving voltage drive_voltage at a voltage level which is lower than that of the external voltage VDD when the write signal WTB is inactivated.

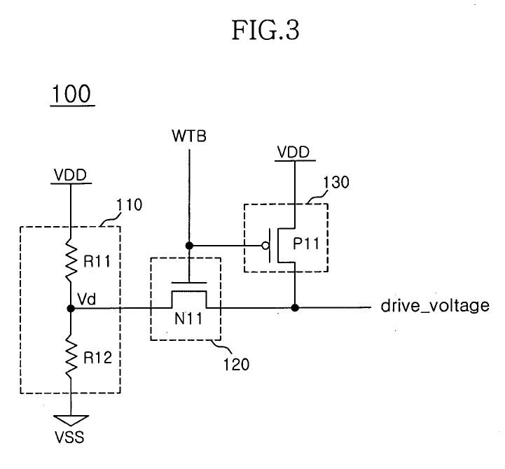

As shown in FIG. 3, the driving voltage generating unit 100 can include a division voltage generating unit 110, a division voltage output unit 120, and an external voltage output unit 130.

The division voltage generating unit 110 can be configured to generate a division voltage Vd by dividing the external voltage VDD. The division voltage generating unit 110 can include a first resistor R11 and a second resistor R12. The external voltage VDD is applied to one end of the first resistor R11. One end of the resistor R12 is coupled to the other end of the resistor R11 and the other end of the resistor R12 is coupled to a ground voltage terminal VSS. At this time, the division voltage Vd is output from a connection node between the first resistor R11 and the second resistor R12.

The division voltage output unit 120 can be configured to output the division voltage Vd, as the driving voltage drive_voltage, when the write signal WTB is inactivated at a high level. The division voltage output unit 120 can include a first transistor N11 which outputs through a source the division voltage Vd as the driving voltage drive_voltage, which is applied to a drain in response to the write signal WTB applied to a gate thereof.

The external voltage output unit 130 can be configured to output the external voltage as the driving voltage drive_voltage when the write signal WTB is activated at a low level. The external voltage output unit 130 can include a second transistor P11 which outputs through a drain the external voltage VDD, as the driving voltage drive_voltage, which is applied to a source in response to the write signal WTB applied to a gate thereof.

Referring to FIG. 3, in the division voltage generating unit 110, the voltage division rate of the external voltage VDD can be determined by the resistance values of the resistors R11 and R12. The division voltage generating unit 110 divides the external voltage VDD according to the determined voltage division rate. In the case where the write signal WTB is inactivated at a high level, the division voltage Vd is output as the driving voltage drive_voltage. Meanwhile, when the write signal WTB is activated at a low level, the external voltage VDD is output as the driving voltage drive_voltage.

As a result, when the write signal WTB is activated, the driving voltage generating unit 100 according to an example of one embodiment can generate the driving voltage drive_voltage which is higher than that produced when the write signal WTB is inactivated.

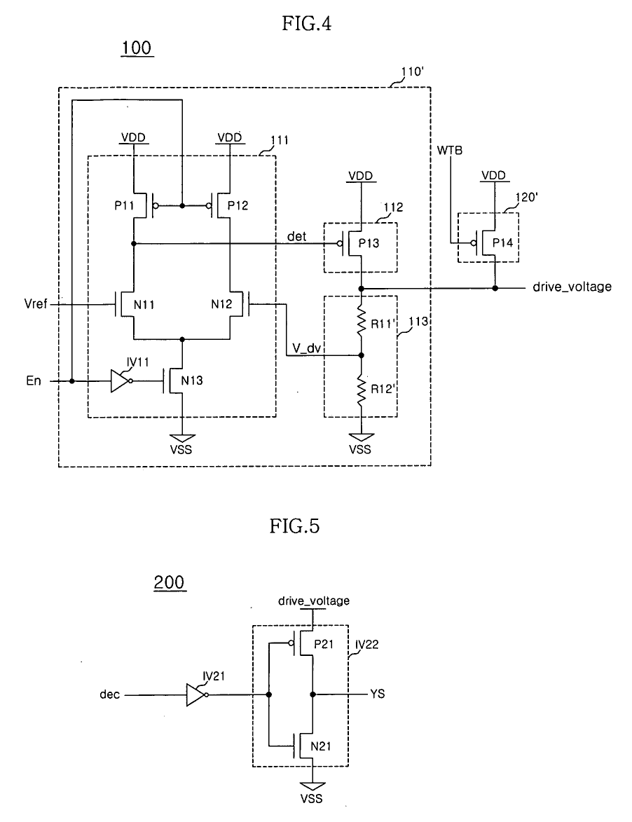

Furthermore, as shown in FIG. 4, a driving voltage generating unit 100′ according to another example of the driving voltage generating unit of FIG. 2 can include a voltage generating unit 110′ and a voltage supply unit 120′.

The voltage generating unit 110′ can include a comparator 111, a driver 112, and a voltage dividing unit 113.

The comparator 111 can be configured to compare a reference voltage Vref with a division voltage V_dv when an enable signal En is activated and then generate a detection signal det.

This comparator 111 can include a first inverter IV11 and first to fifth transistors N11 to N13, P11 and P12. The first inverter IV11 receives the enable signal En. The reference signal Vref is applied to a gate of the first transistor N11. The division voltage V_dv is applied to a gate of the second transistor N12. The third transistor N13 has a gate to which an output signal of the first inverter IV11 is applied, a drain which is connected to sources of the first and second transistors N11 and N12, and a source to which a ground voltage (VSS) terminal is connected. The fourth transistor P11 has a gate to which the enable signal En is applied, a source which is connected to the external voltage (VDD) terminal, and a drain to which a drain of the first transistor N11 is connected. The fifth transistor P12 has a gate to which the enable signal En is applied, a source which is connected to the external voltage (VDD) terminal, and a drain to which a drain of the second transistor N12 is connected. At this time, the detection signal det is output from a connection node between the first and fourth transistors N11 and P11.

The driver 112 can be configured to output the driving voltage drive_voltage by driving the external voltage VDD according to the voltage level of the detection signal det. The driver 112 can include a sixth transistor P13. The sixth transistor P13 has a gate to which the detection signal det is applied, a source to which the external voltage VDD is applied, and a drain through which the driving voltage drive_voltage is output.

The voltage dividing unit 113 can be generated the division voltage V_dv by dividing the driving voltage drive_voltage. The voltage dividing unit 113 can include a first resistor R11′ and a second resistor R12′. The external voltage VDD is applied to one end of the first resistor R11′. One end of the resistor R12′ is coupled to the other end of the resistor R11′ and the other end of the resistor R12′ is coupled to the ground voltage (VSS) terminal. At this time, the division voltage V_dv is output from a connection node between the first resistor R11′ and the second resistor R12′.

When the write signal WTB is activated, the voltage supply unit 120′ outputs the driving voltage drive_voltage at the voltage level of the external voltage VDD, by applying the external voltage VDD to an output node of the voltage generating unit 110′. The voltage supply unit 120′ can include a seventh transistor P14 and the seventh transistor P14 has a gate to which the write signal WTB is applied, a source to which the external voltage VDD is applied, and a drain which is connected to the output node of the voltage generating unit 110′.

The operation of the driving voltage generating unit 100 of FIG. 4 will be described in detail below. First, if the enable signal En is activated, the comparator 111 is enabled. The enabled comparator 111 can compare the reference voltage Vref with the division voltage V_dv and then produces the detection signal det. For example, the comparator 111 activates the detection signal det at a low level when the reference voltage Vref is higher than the division voltage V_dv. Furthermore, the comparator 111 can be configured to inactivate the detection signal det at a high level when the reference voltage Vref is lower than the division voltage V_dv.

The driver 112 can be configured to drive the external voltage VDD according to the voltage level of the detection signal det, thereby outputting the driving voltage drive_voltage. For example, the driving operation of the driver 112 is not carried out when the detection signal det is inactivated at a high level. On the other hand, the driver 112 drives the external voltage VDD when the detection signal det is activated at a low level. The drivability of the driver 112 is controlled by the voltage level of the detection signal det. The reason why the driver 112 is controlled by the voltage level of the detection signal det is that the driver 112 includes the turn-on strength of the sixth transistor P13 is determined by the gate voltage signal (i.e., the detection signal det). Accordingly, the driving voltage drive_voltage, which is output from the driver 112, is lower than the external voltage VDD.

The voltage dividing unit 113 can be configured to generate the division voltage V_dv by dividing the driving voltage drive_voltage.

Therefore, when the division voltage V_dv is higher than the reference voltage Vref, the detection signal det is inactivated and then the driving operation is not carried out by the driver 112. Furthermore, when the division voltage V_dv is lower than the reference voltage Vref, the detection signal det is activated and then the driving operation is carried out by the driver 112. Accordingly, the driving voltage drive_voltage which is generated by only the voltage generating unit 110′ is lower than the external voltage VDD.

If the write signal WTB, which is activated at a ground voltage level, is input into the voltage supply unit 120, the external voltage VDD is applied to the output terminal of the voltage generating unit 110′. That is, the driving voltage drive_voltage is the same as the external voltage VDD. When the driving voltage drive_voltage goes to the external voltage VDD, the comparator 111 outputs the inactivated detection signal det and there is no an output signal from the voltage generating unit 110′.

As a result, the driving voltage generating unit 100 can be configured to output the driving voltage drive_voltage of which the voltage level is lower than that of the external voltage VDD. However, while the write signal WTB is activated, the driving voltage generating unit 100 outputs the external voltage VDD as the driving voltage drive_voltage.

The column select signal driving unit 200 can be configured to output the driving voltage drive_voltage, as a column select signal YS, in response to an enabled decoding signal dec which is provided from a column decoder (not shown). At this time, the decoding signal dec can be generated by decoding address signals.

As shown in FIG. 5, the column select signal driving unit 200 can include a second inverter IV21 and a third inverter IV22.

The second inverter IV21 inverts the decoding signal dec and the third inverter IV22, which receives an output signal of the second inverter IV21, outputs the column select signal YS. At this time, the driving voltage drive_voltage is applied to the third inverter IV22.

The third inverter IV22 can include a ninth transistor P21 and a tenth transistor N21. The ninth transistor P21 has a gate to which the output signal of the second inverter IV21 is applied and a source to which the driving voltage drive_voltage is applied. The tenth transistor N21 has a gate to which the output signal of the second inverter IV21 is applied, a drain to which an output signal of the ninth transistor P21 is applied, and a source which is connected to the ground voltage (VSS) terminal. At this time, the column select signal YS is outputted from a connection node between the ninth transistor P21 and the ninth transistor N21.

The operation of the column select signal voltage adjusting circuit according to one embodiment will be described in detail

The column select signal driving unit 200 outputs the driving voltage generating unit 100, as the column select signal YS, in response to the enabled decoding signal dec. That is, the column select signal driving unit 200 outputs the column select signal YS, which is lower than the external voltage VDD, when the write signal WTB is inactivated and, therefore, the column select signal YS may be the division voltage drive_voltage. When the write signal WTB is activated, the column select signal driving unit 200 outputs the column select signal YS at the voltage level of the external voltage VDD.

The turn-on states of the transistor N2 and N3, which implement the data transmission switching unit 50 of FIG. 5, can be determined by the voltage level of the column select signal YS. For example, when the voltage level of the column select signal YS is lower than the external voltage VDD, the turn-on strength of the transistors N2 and N3 becomes low. Here, the turn-on strength can mean the turn-on speed of the transistors or an amount of current flowing into the transistors.

Accordingly, in the case where the data are transferred from the pair of bit lines to the pair of the data, the division voltage V_dv, which is lower than the external voltage VDD, is inputted, as the column select signal YS, into the data transmission switching unit 50. Therefore, the turn-on strength of the transistors in the data transmission switching unit 50 becomes low and thus the parasite capacitance is less influenced on the pair of bit lines BL and BLB.

As a result, at the read operation of the semiconductor memory apparatus, the data line interference caused by the bit line can be prevented.

While the present invention has been described with respect to the particular embodiments, it will be apparent to those skilled in the art that various changes and modifications may be made without departing from the spirit and scope of the invention as defined in the following claims.

What is claimed is:

1. A column select signal voltage adjusting circuit of a semiconductor memory apparatus comprising:
a driving voltage generating unit configured to generate a driving voltage when the write signal is activated, wherein a voltage level of the driving voltage generated when the write signal is activated is higher than a voltage level of the driving voltage generated when the write signal is inactivated; and
a column select signal driving unit configured to output a column select signal by driving a decoding signal to the voltage level of the driving voltage.

2. The column select signal voltage adjusting circuit of claim 1,
wherein the driving voltage generating unit is configured to generate the driving voltage of a first voltage level when the write signal is activated and generate the driving voltage of a second voltage level when the write signal is inactivated, wherein the first voltage level is a voltage level of an external voltage level, and wherein the second voltage level is correspondent to a voltage level of a reference voltage.

3. The column select signal voltage adjusting circuit of claim 2, wherein the driving voltage generating unit is configured to generate the driving voltage which has a voltage level corresponding to the reference voltage level and wherein the driving voltage generating unit is configured to generate the driving voltage which has the external voltage level when the write signal is activated.

4. The column select signal voltage adjusting circuit of claim 2, wherein the driving voltage generating unit includes:
a voltage generating unit configured to compare the reference voltage with the driving voltage and generate the driving voltage having a voltage level corresponding to the reference voltage level; and
a voltage supply unit configured to output the driving voltage having the external voltage level by applying the external voltage to an output terminal of the voltage generating unit when the write signal is activated.

5. The column select signal voltage adjusting circuit of claim 4, wherein the voltage generating unit includes:
a comparator configured to compare the reference voltage with a division voltage and producing a detection signal;
a driver configured to output the driving voltage by driving the external voltage according to the detection signal; and
a voltage dividing unit configured to generate the division voltage by dividing the driving voltage.

6. The column select signal voltage adjusting circuit of claim 1, wherein the driving voltage generating unit is configured to output the external voltage as the driving voltage, when the write signal is activated, and output a division voltage, which is produced by dividing the external voltage, as the driving voltage when the write signal is inactivated.

7. The column select signal voltage adjusting circuit of claim 6, wherein the driving voltage generating unit includes:
a division voltage generating unit configured to generate the division voltage by dividing the external voltage;
a division voltage output unit configured to output the division voltage, as the driving voltage, in response to the write signal; and
an external voltage output unit configured to output the external voltage, as the driving voltage, in response to the write signal.

8. The column select signal voltage adjusting circuit of claim 7, wherein the division voltage output unit includes a first switching element which outputs the division voltage, as the driving voltage, in response to the write signal, wherein the external voltage output includes a second switching element which outputs the external voltage, as the driving voltage, in response to the write signal, and wherein the driving voltage is output from a connection node between output terminals of the first and second switching elements.

9. The column select signal voltage adjusting circuit of claim 1, wherein the column select signal driving unit includes a driver which receives the driving voltage and then drives the decoding signal.

10. A column select signal voltage adjusting circuit of a semiconductor memory apparatus comprising:
a driving voltage generating unit configured to receive a reference voltage and generate a driving voltage which has a voltage level corresponding to the reference voltage and configured to generate the driving voltage, which has a voltage level of an external voltage, in response to a write signal; and
a column select signal driving unit configured to output a column select signal by driving a decoding signal to the voltage level of the driving voltage.

11. The column select signal voltage adjusting circuit of claim 10, wherein the driving voltage generating unit includes:
a voltage generating unit configured to compare the reference voltage with the driving voltage and generate the driving voltage having a voltage level corresponding to the reference voltage level; and
a voltage supply unit configured to output the external voltage, as the driving voltage, in response to the write signal.

12. A semiconductor memory apparatus comprising:
a column select signal voltage adjusting circuit configured to generate a column select signal when the write signal is activated, wherein a voltage level of the column select signal generated when the write signal is activated is higher than a voltage level of the column select signal produced when the write signal is inactivated; and
a data transfer switching unit configured to coupled a pair of bit lines to a pair of data lines in response to the column select signal.

13. The semiconductor memory apparatus of claim 12, wherein the column select signal voltage adjusting circuit includes:
a driving voltage generating unit configured to compare a reference voltage with the driving voltage and producing the driving voltage having a voltage level corresponding to the reference voltage level and for outputting an external voltage, as the driving voltage, when the write signal is activated; and
a column select signal driving unit configured to output the column select signal by driving a decoding signal to a voltage level of the driving voltage.

14. The semiconductor memory apparatus of claim 13, wherein the driving voltage generating unit outputs, as the driving voltage, a division voltage which is produced by dividing the external voltage when the write signal is inactivated and outputs, as the driving voltage, the external voltage when the write signal is activated.

15. The semiconductor memory apparatus of claim 12, wherein the data transfer switching unit includes transistors having gates to which the column select signal is applied and source and drains to couple the pair of the bit lines to the pair of the data lines.
